(19) United States
(12) Patent Application Publication
(10) Pub. No.: US 2024/0199297 A1
(43) Pub. Date: Jun. 20, 2024

(54) PORTABLE WATER SUPPLY

(71) Applicant: Marlido, LLC, Darien, CT (US)

(72) Inventors: William SEIBOLD, Darien, CT (US); Paul WALTON, Darien, CT (US); Joseph MCARDLE, Darien, CT (US); Sally NG, Darien, CT (US)

(73) Assignee: Marlido, LLC, Darien, CT (US)

(21) Appl. No.: 18/083,040

(22) Filed: Dec. 16, 2022

(51) Int. Cl. B65D 77/06; B62B 1/12; B62B 5/06; B65D 21/08; B65D 25/28; B65D 77/20

(52) U.S. Cl. CPC B65D 77/068; B62B 1/12; B62B 5/067; B65D 21/086; B65D 25/28; B65D 77/2004; B65D 2525/287

(57) ABSTRACT

A portable apparatus suitable for storing liquids, such as water for consumption. The portable water storage apparatus includes a base, a lid, a plurality of panels, and flexible bladder. The plurality of panels has a folded configuration that forms a stack of overlapping panels in a compact storage configuration of the apparatus, and an unfolded configuration in which the panels extend from the base to the lid forming a chamber in a fill configuration of the apparatus. The chamber is configured to contain the flexible bladder. The base and the lid each may include a hole through which fluid filling and fluid dispensing attachments may be coupled to orifices in the flexible bladder. In a transport configuration of the apparatus, a planar base surface of the base may be oriented vertically, and wheels and telescoping handle of the base are disposed for rolling movement of the apparatus under human force.

### FIELD OF THE DISCLOSURE

The present invention relates to fluid storage and more specifically relates to water storage and portability.

### BACKGROUND

As fluid storage tanks are filled, mobility becomes difficult by human force alone as weight increases. In times of emergencies, such as after natural disasters, a small scale, mobile, dedicated, and rapidly fillable source of potable water is often required. Storage tanks having sufficient capacity allowing users to prepare an emergency water supply may be too heavy to easily move from a water source to shelter. The US Federal Emergency Management Agency (FEMA) suggests that a two-person family requires one gallon of water per person, per day, to comfortably survive for two weeks. The volume of such a tank sufficient to hold this amount of water, roughly 28 gallons, can be heavy and difficult to keep sanitary. Filling a tank with such a substantial amount of water can be time consuming. Filling a tank with such a substantial amount of water can be time consuming. In some cases, water sources available to citizens that can fill a storage tank are limited to a faucet or spigot. Filling tanks from such sources may be time consuming. Filling tanks from such sources may also limit the size of the storage means capable of receiving water from such as source, for example a bucket. In emergency situations, however, time may be limited.

### SUMMARY

What is needed is an apparatus for providing an emergency potable water supply that is easily movable. What is needed is a collapsible and/or storable apparatus for transporting, storing, and dispensing water. What is needed is a storable apparatus that is readily assembled and filled with potable water before, during, and/or after natural disasters or other emergency scenarios. What is needed is a water storage apparatus that can be easily moved, in a compact, stable format, from the filling source to other areas despite the large weight of an apparatus that is filled with potable water.

Embodiments described herein may include a portable apparatus suitable for storing liquids, such as potable water for consumption, during periods when ordinary drinking water may be less available or unavailable. Embodiments of the apparatus may have a collapsed configuration for storage in a small profile arrangement. In an embodiment, the portable apparatus includes a base, a lid, a plurality of panels, and a flexible bladder. The plurality of panels has a folded configuration that forms a stack of overlapping panels in a recess in the base when in the collapsed configuration of the apparatus. The plurality of panels has an unfolded configuration in which the panels extend from the base to the lid forming a chamber defined by the plurality of panels, the base, and the lid. The chamber is configured to contain the flexible bladder. The base and the lid each may include a hole through which a fluid filling attachment and a fluid dispensing attachment may be coupled to orifices in the flexible bladder. Some embodiments may provide for a detachable coupling with a hose to connect embodiments of a water storage apparatus to a water source, such as a household faucet.

In an embodiment, the water storage apparatus may be assembled in one location and rolled to a water source. In an embodiment, the apparatus includes a base, a lid, a plurality of panels, and a flexible bladder. The base includes a lower surface, a wheel assembly attached to the base, and a handle mounted to the base. In a transport configuration of the water storage apparatus, the wheel assembly is disposed for rolling movement of the water storage apparatus, the lower surface of the base is oriented vertically, and the handle is disposed for propelling the rolling movement. The handle may be a telescoping handle that may be extended for propelling the rolling movement. The water storage apparatus may include an assembly configuration in which the lower surface of the base is a lower horizontal surface and an upper surface of the lid is an upper horizontal surface. The plurality of panels may be foldably coupled to the base, wherein the panels may be folded for compact storage and unfolded in the assembly configuration of the water storage apparatus.

In another embodiment, a water storage apparatus includes a base comprising a planar base surface and a plurality of base walls extending from edges of the base walls adjacent the planar base surface to opposite edges of the base walls non-adjacent the planar base surface. The plurality of base walls forming a recess in the base defined by the base walls and the planar base surface. At least one of the plurality of base walls has a first hole configured to be detachably coupled to a fluid dispenser. The water storage apparatus includes a lid comprising a planar lid surface and a plurality of lid walls extending from edges of the lid walls adjacent the planar lid surface to opposite edges of the lid walls non-adjacent the planar lid surface, wherein the planar lid surface has a second hole.

The water storage apparatus further includes a plurality of panels coupled to the opposite edges of the base walls. The panels have a folded configuration in which the panels form a stack of overlapping panels covering the recess in the base. The panels have an unfolded configuration in which the plurality of panels extend from the base to the lid forming a chamber defined by the plurality of panels, the base, and the lid. A flexible bladder including an orifice may be housed within the chamber and substantially aligned with the second hole in the planar lid surface.

In yet another embodiment, a water storage apparatus includes a base including a lower surface, a wheel assembly attached to the base, a handle mounted to the base, and a plurality of walls extending upwardly from edges of the lower surface to upper edges of the walls. The plurality of walls forms a recess in the base defined by the walls and the lower surface, wherein at least one of the plurality of walls has a hole. The apparatus includes a lid with an upper surface having a plurality of walls extending downwardly from edges of the upper surface. In an embodiment, the lid walls and the upper surface of the lid define a recess in the lid, wherein the upper surface includes a hole.

The additional embodiment further includes a plurality of panels foldably coupled to the upper edges of the walls of the base. The panels have a folded configuration forming a stack of overlapping panels covering the recess in the base. The apparatus further includes a flexible bladder including an orifice substantially aligned with the hole in the upper surface of the lid. In a transport configuration of the water storage apparatus, the wheel assembly is disposed for rolling movement of the water storage apparatus, the lower surface of the base is oriented vertically, and the handle is disposed for propelling the rolling movement.

In another embodiment, a water storage apparatus comprises a base comprising a planar base surface and a plurality of base walls extending from edges of the base walls adjacent the planar base surface to opposite edges of the base walls non-adjacent the planar base surface, forming a recess in the base defined by the base walls and the planar base surface, wherein at least one of the plurality of base walls has a first hole configured to be detachably coupled to a fluid dispenser; a lid comprising a planar lid surface and a plurality of lid walls extending from edges of the lid walls adjacent the planar lid surface to opposite edges of the lid walls non-adjacent the planar lid surface, wherein the planar lid surface has a second hole; a plurality of panels coupled to the opposite edges of the base walls, wherein the panels have a folded configuration in which the panels form a stack of overlapping panels in the recess in the base, wherein the panels have an unfolded configuration in which the plurality of panels extend from the base to the lid forming a chamber defined by the plurality of panels, the base, and the lid; and a flexible bladder comprising an orifice substantially aligned with the second hole in the planar lid surface.

In yet another embodiment, a water storage apparatus comprises a base comprising a lower surface, a wheel assembly attached to the base, a handle mounted to the base, and a plurality of walls extending upwardly from edges of the lower surface to upper edges of the walls forming a recess in the base defined by the walls and the lower surface, wherein at least one of the plurality of walls has a hole; a lid comprising an upper surface having a plurality of walls extending downwardly from edges of the upper surface, forming a recess in the lid defined by the lid walls and the upper surface, wherein the upper surface comprises a hole; a plurality of panels foldably coupled to the upper edges of the walls of the base, wherein the panels have a folded configuration in which the panels form a stack of overlapping panels covering the recess in the base; and a flexible bladder comprising an orifice substantially aligned with the hole of the upper surface, wherein in a transport configuration of the water storage apparatus the wheel assembly is disposed for rolling movement of the water storage apparatus, the lower surface of the base is oriented vertically, and the handle is disposed for propelling the rolling movement.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows a perspective view of assembled base and lid of a portable water storage apparatus with panels in folded configuration for compact storage, according to an embodiment.

FIG. 2 shows disassembled base and lid of a portable water storage apparatus with panels in folded configuration, according to an embodiment.

FIG. 3A shows a perspective view of integrated latching buckle in closed configuration, according to the embodiment of FIGS. 3A and 3B.

FIG. 3B shows a perspective view of integrated latching buckle in closed configuration, according to the embodiment of FIGS. 3A and 3B.

FIG. 4 shows a perspective view of transport configuration of a portable water storage apparatus assembled for compact storage, according to an embodiment.

FIG. 5 shows a perspective view of partially assembled portable water storage apparatus in horizontal assembly configuration with lid removed, according to an embodiment.

FIG. 6 shows a perspective view of fully assembled portable water storage apparatus in horizontal assembly configuration, according to an embodiment.

FIG. 7A shows a perspective view of a flexible bladder, according to the embodiment of FIGS. 7A and 7B.

FIG. 7B shows a close-up view of an outlet of a flexible bladder, according to the embodiment of FIGS. 7A and 7B.

FIG. 8 shows a perspective view of fully assembled portable water storage apparatus in transport configuration, according to an embodiment.

FIG. 9A shows an elevated view of a telescoping handle assembly with handle retracted, according to the embodiment of FIGS. 9A and 9B.

FIG. 9B shows an elevated view of a telescoping handle assembly with handle extended, according to the embodiment of FIGS. 9A and 9B.

FIG. 10 shows an end view of fully assembled portable water storage apparatus in horizontal assembly configuration, according to an embodiment.

FIG. 11 shows an elevation view of the lower surface of the base of a portable water storage apparatus in vertical transport configuration with handle retracted, according to an embodiment.

FIG. 12 shows a perspective view of a fully assembled portable water storage apparatus in vertical fill configuration, according to an embodiment.

FIG. 13 shows a perspective view of a nozzle for a portable water storage apparatus, according to an embodiment.

FIG. 14 shows a perspective view of a garden hose adapter for a portable water storage apparatus, according to an embodiment.

FIG. 15 shows a perspective view of a household faucet aerator adapter for a portable water storage apparatus, according to an embodiment.

FIG. 16 shows a perspective view of a water dispenser attachment with nozzle for a portable water storage apparatus, according to an embodiment.

FIG. 17 shows a perspective view of a water dispenser attachment with garden hose adapter for a portable water storage apparatus, according to an embodiment.

FIG. 18A shows an isometric bottom view of fully assembled portable water storage apparatus with handle extended, according to an embodiment.

FIG. 18B shows an isometric top view of fully assembled portable water storage apparatus with handle extended, according to an embodiment.

FIG. 18C shows an isometric right side view of fully assembled portable water storage apparatus with handle extended, according to an embodiment.

FIG. 18D shows an isometric bottom view of left side view of fully assembled portable water storage apparatus with handle extended, according to an embodiment.

FIG. 19A shows an isometric bottom view of compact storage configuration of portable water storage apparatus with handle retracted, according to an embodiment.

FIG. 19B shows an isometric front side view of compact storage configuration of portable water storage apparatus with handle retracted, according to an embodiment.

FIG. 19C shows an isometric top view of compact storage configuration of portable water storage apparatus, according to an embodiment.

### DETAILED DESCRIPTION

The present invention is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Some conventional water storage systems, such as bathtub water bladders and large water tanks, are susceptible to waste, spillage, and mess. Some conventional storage systems for storing emergency water supplies are often located at a great distance from where the majority of water is consumed for drinking and cooking, such as the kitchen or dining room. In some conventional storage systems, repeated instances of mobilizing the water from storage areas to consumption areas often invites spillage and/or contamination.

In emergency situations, high-rise apartment homes that lose power can also lose electricity-driven water pressure. For residents of high-rise apartment homes, particularly those who live on higher-floors, it may be impracticable to move the requisite amount of water quickly, safely, and without contaminating the water supply.

For residents of suburban and rural communities, when natural disasters strike local water supplies can be temporarily unavailable or contaminated. Often alternative water sources are not possible due to road closures, floods, snow, distances, and/or debris.

In some cases, it may even be useful for municipalities and other government agencies to distribute storage tanks to its citizens following natural disasters. Such large-scale water distribution may reduce the amount of time lost to provide potable water rations and reduce that amount of water spilled by distributing water in small, makeshift water receptacles. Municipalities and other government agencies may distribute the present invention to groups of citizens to provide temporary and safe supplies of water to their citizens.

In situations commonly requiring emergency water provisions, such as before a bad weather event, citizens often buy large stores of bottled water in anticipation. This can be expensive, and may distract from other needs when preparing for an impending emergency.

Embodiments may provide a readily available capability to store an emergency supply of potable water from any house faucet or spigot, in a short period of time. In some embodiments, the capacity of this supply may meet or exceed the FEMA-suggested 14-gallons per person amount (28 gallons for a two-person family), and without sacrificing mobility or safety. In illustrative embodiments, the water storage apparatus of the disclosure includes a two person version that provides a larger capacity, e.g., 28 gallons, and a one person version that provides a smaller capacity, e.g., 14 gallons.

Embodiments may provide a rapidly fillable source of potable water that municipalities or other government agencies may distribute to citizens following disasters and in other emergencies. Such embodiments may facilitate water distribution to citizens in larger amounts thereby reducing waste and contamination in makeshift receptacles (e.g., buckets).

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are considered within the scope of the invention.

In an embodiment, a water storage apparatus includes a base comprising a planar base surface and a plurality of base walls extending from edges of the base walls adjacent the planar base surface to opposite edges of the base walls non-adjacent the planar base surface. The plurality of base walls forms a recess in the base defined by the base walls and the planar base surface. At least one of the plurality of base walls has a first hole configured to be detachably coupled to a fluid dispenser. The water storage apparatus includes a lid comprising a planar lid surface and a plurality of lid walls extending from edges of the lid walls adjacent the planar lid surface to opposite edges of the lid walls non-adjacent the planar lid surface, wherein the planar lid surface has a second hole.

The water storage apparatus further includes a plurality of panels coupled to the opposite edges of the base walls. The panels have a folded configuration in which the panels form a stack of overlapping panels covering the recess in the base. The panels have an unfolded configuration in which the plurality of panels extend from the base to the lid forming a chamber defined by the plurality of panels, the base, and the lid. The apparatus further includes a flexible bladder including an orifice is substantially aligned with the second hole in the planar lid surface.

The water storage apparatus may further include a telescoping handle mounted to the planar base surface of the base. The telescoping handle may be formed of concentric tubular sections configured to slide relative to one another.

In an embodiment, the plurality of panels includes two end panels and two side panels foldably coupled to hinges at the opposite edges of the base walls. The stack of overlapping panels may include two side panels overlapping each other, wherein the two side panels are partially covered by the two end panels. In an embodiment, the lid includes a plurality of fasteners configured to secure the lid to the base walls in the folded configuration of the plurality of panels and configured to secure the lid to the plurality of panels in the unfolded configuration of the plurality of panels.

The flexible bladder may further comprise an orifice detachably connected to the first hole in one of the base walls. A fluid dispenser may detachably couple to the first hole, wherein the fluid dispenser may be a spigot or a hose. In an embodiment, the lid forms a recess defined by the lid walls and the planar lid surface. The apparatus may further include a removable cap sealing the second hole in the planar lid surface. In an embodiment, the apparatus further includes a detachable hose connected to the second hole in the planar lid surface.

In an embodiment, the water storage apparatus includes wheels removably attached to the planar base surface. The water storage apparatus may further include an axle attached to the base, wherein the wheels are rotatably coupled to the axle. The water storage apparatus may further include an axle protruding from a first wall of the plurality of base walls, wherein the wheels comprise outboard wheels rotatably coupled to the axle.

In additional embodiments described herein, a water storage apparatus includes a base including a lower surface, a wheel assembly attached to the base, a handle mounted to the base, and a plurality of walls extending upwardly from edges of the lower surface to upper edges of the walls. The plurality of walls forms a recess in the base defined by the walls and the lower surface, wherein at least one of the plurality of walls has a hole. The apparatus includes a lid with an upper surface having a plurality of walls extending downwardly from edges of the upper surface. The lid walls form a recess in the lid defined by the lid walls and the upper surface, wherein the upper surface includes a hole.

The additional embodiments of water storage apparatus further include a plurality of panels foldably coupled to the upper edges of the walls of the base. The panels have a folded configuration in which the panels form a stack of overlapping panels covering the recess in the base. The apparatus further includes a flexible bladder including an orifice substantially aligned with the hole of the upper surface. In a transport configuration of the water storage apparatus the wheel assembly is disposed for rolling movement of the water storage apparatus, the lower surface of the base is oriented vertically, and the handle is disposed for propelling the rolling movement. In an embodiment, the handle is a telescoping handle which may be extended for propelling the rolling movement in the transport configuration of the water storage apparatus. The telescoping handle may be formed of concentric tubular sections configured to slide relative to one another.

In an assembly configuration of the water storage apparatus, the lower surface of the base is a lower horizontal surface, the upper surface of the lid is an upper horizontal surface. The folded configuration of the panels forms a horizontal stack of overlapping panels covering the recess in the base. In an embodiment, the panels have an unfolded configuration in which the plurality of panels extends from the base to the lid forming a chamber defined by the plurality of panels, the base, and the lid. In an embodiment, the lid includes a plurality of fasteners configured to secure the lid to the walls of the base in the folded configuration of the plurality of panels and configured to secure the lid to the plurality of panels in the unfolded configuration of the plurality of panels.

In various embodiments, the wheel assembly is removably attached at a lower side of the lower horizontal surface of the base in the assembly configuration of the water storage apparatus. The wheel assembly may include an axle that protrudes from first and second walls of the plurality of walls of the base and outboard wheels rotatably coupled to the axle. The wheel assembly may include an axle attached to the base and recessed wheels rotatably coupled to the axle.

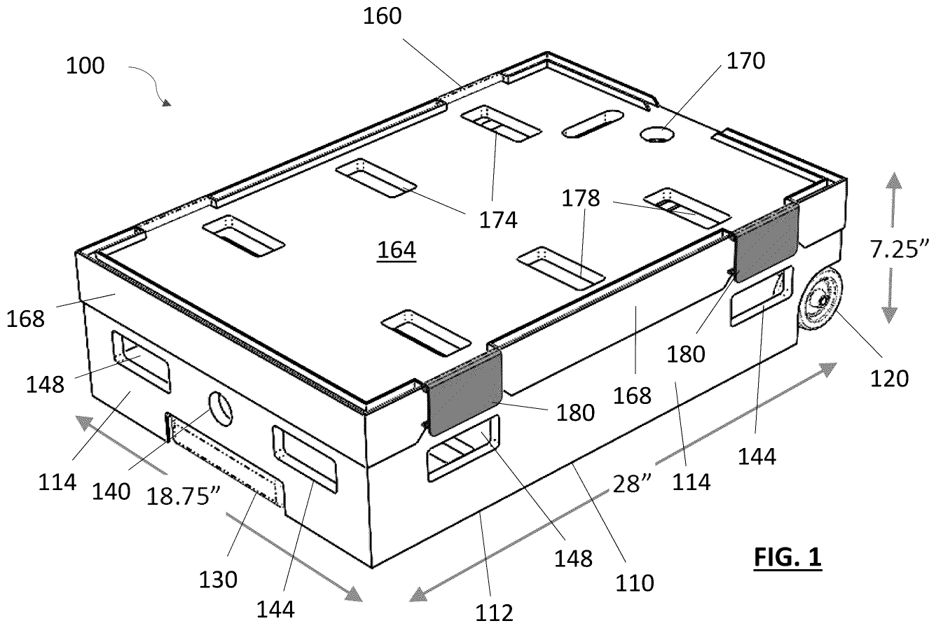

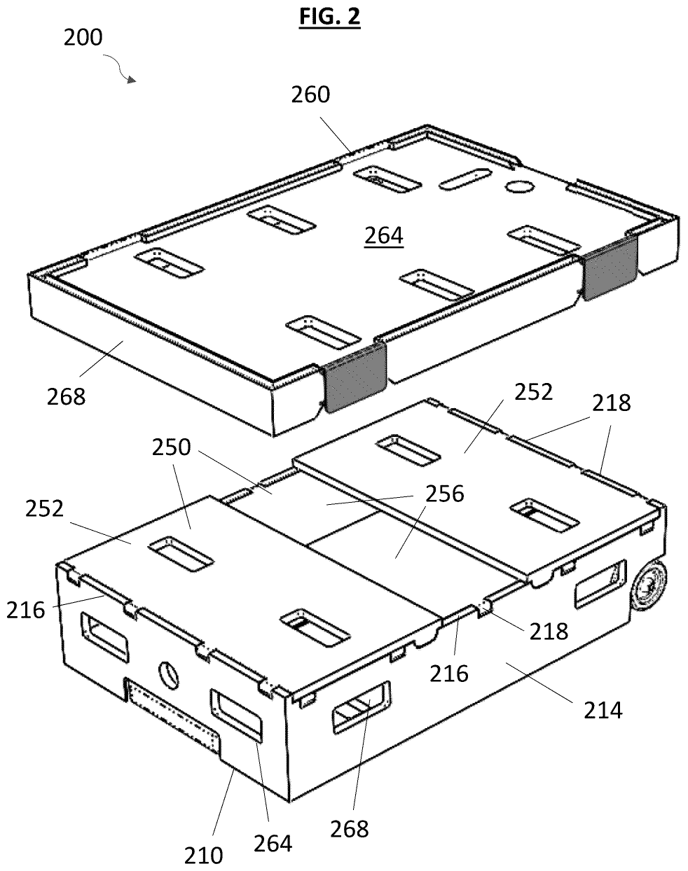

FIG. 1 shows an exemplary embodiment of an assembled base 110 and lid 160 of a portable water storage apparatus 100 in compact storage configuration. The base includes base walls 114 that extend from edges 112 of the base walls adjacent a planar base surface (not shown in this view) to opposite edges of the base walls that are non-adjacent the planar base surface, e.g., as seen at edges 216 in FIG. 2. In the orientation shown, the planar base surface forms a lower horizontal surface, and the base walls 114 extend upwardly from the lower horizontal surface to upper edges of the side walls. In a rectangular configuration of base walls 114 shown, the base walls 114 include shorter end walls (such as the 18.75″ wall at lower left) and longer side walls (such as the 28″ wall at lower right).

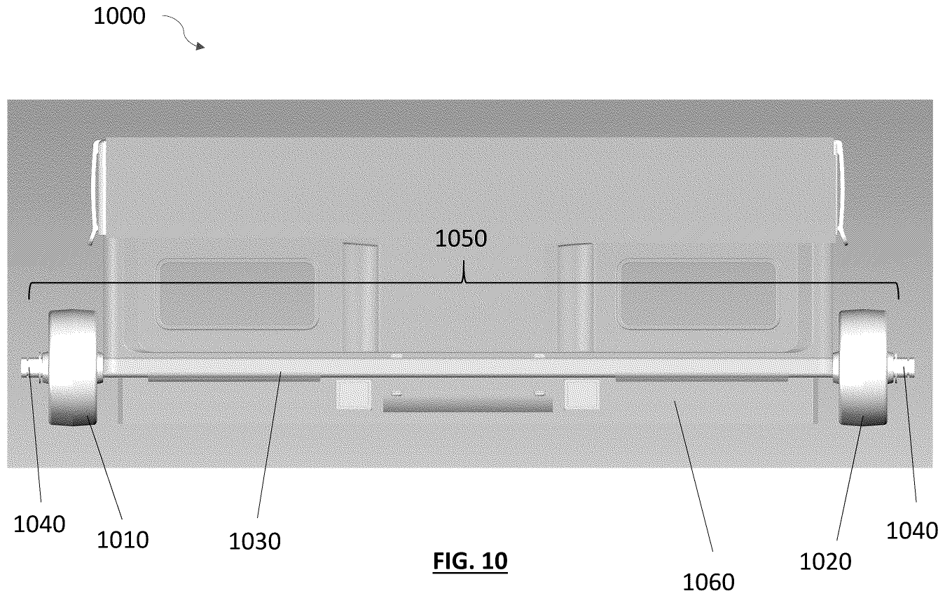

The base 110 may comprise a number of wheels 120. In some embodiments, wheels 120 may be removably attached and rotatably coupled to an exterior facing, or planar base surface, of the base 110. In some embodiments, such as shown in FIG. 10, wheels 120 may be removably attached and rotatably coupled to axles protruding from side walls 114 of the base 110. In some embodiments, such axles may be removably coupled to the base walls 114. Embodiments of the wheels 120 may be various sizes capable of mobilizing a water storage apparatus 100 through application of human-generated force.

The base 110 further includes a handle assembly 130, here shown recessed in a base wall 114. In some embodiments, a hole 140 may be formed in the base wall 114. In some embodiments, a cap may be removably placed in the hole 140. The base walls also define a plurality of windows 144 that permit viewing the interior of base 110. In an embodiment, the base walls 114 and planar base surface define a recess 148 within the base.

The lid 160 includes an upper lid surface 164 and downwardly extending lid walls 168. The upper lid surface 164 contains a hole 170. The upper lid surface 164 also may define a plurality of windows 174 that permit viewing the lid interior. In an embodiment, the lid walls 168 and upper lid surface 164 define a recess 178 within the lid.

In the portable water storage apparatus 100 shown in FIG. 1, the lid 160 is secured to the upper edge of the base 110 by fasteners 180 in a compact configuration ready for storage. In some embodiments, detachable components of the portable water storage apparatus may fit within recesses 148, 178 in the storage housing formed by the base 110 and the lid 160.

FIG. 2 shows disassembled base 210 and lid 260 of a portable water storage apparatus 200. The base 210 is coupled to panels 250 in folded configuration. Panels 250 include end panels 252 coupled to shorter sides of the base, and side panels 256 coupled to longer sides of the base. In an embodiment, panels 250 are foldably coupled to base 210 by hinges 218 located at upper edges 216 of the base walls 214. For example, hinges 218 may be barrel hinges or other mechanical bearings allowing substantially 90° angle of rotation of panels 250 between folded configuration of the panels (oriented substantially horizontally) and unfolded configuration of the panels (oriented substantially vertically).

The base includes an interior recess 268 that is visible through windows 264. The panels 250 have a folded configuration that forms a horizontal stack of overlapping panels covering the recess 268 in the base. In an embodiment, in the folded configuration at least some of panels 250 may be located within the recess 268. As shown, the stack of overlapping panels 250 include two side panels 256 overlapping each other, and two end panels 252 that partially cover the two side panels 256.

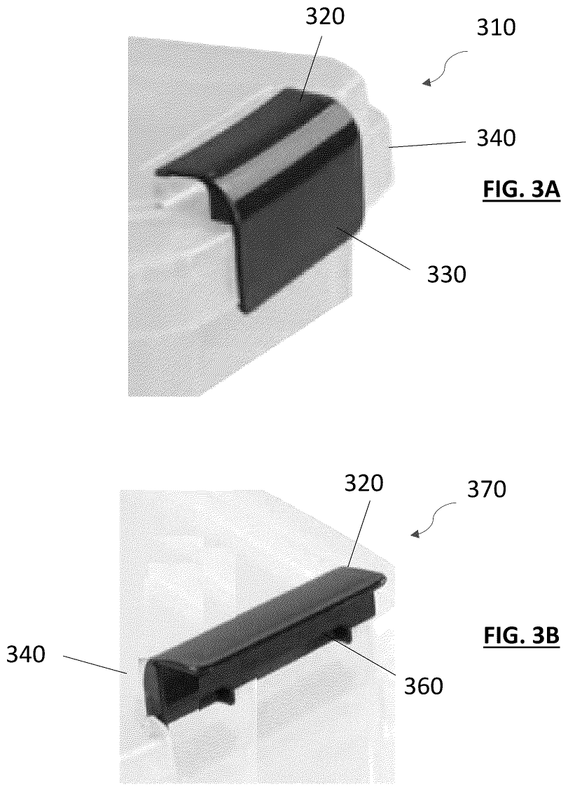

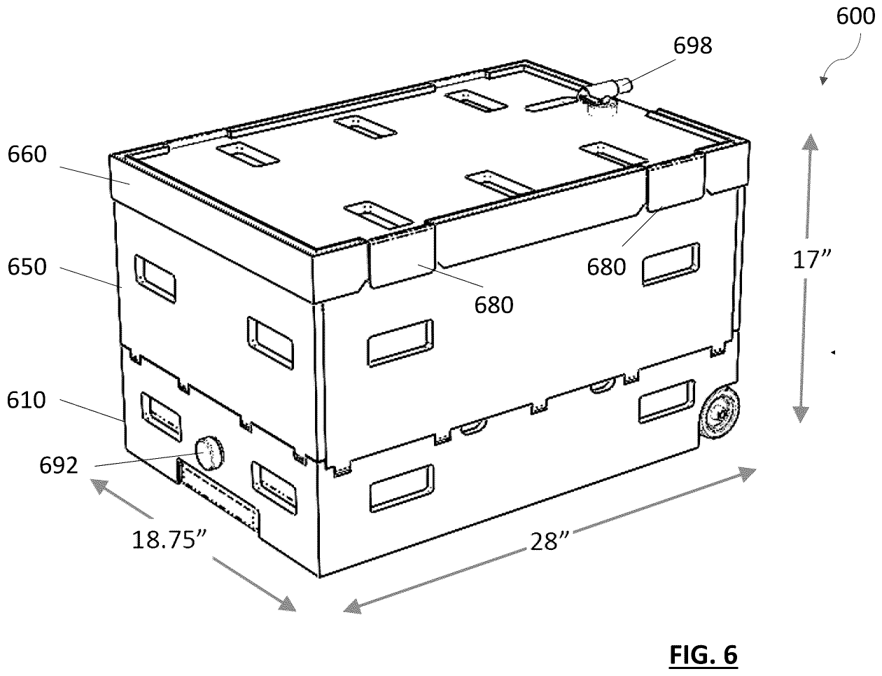

FIGS. 3A and 3B show perspective views of an integrated latching buckle in closed configuration 310 (FIG. 3A) and open configuration 370 (FIG. 3B). In closed configuration, the buckle body 320 securely fastens the lid to an adjacent structure at 330. In open configuration, the buckle body 320 is pivotally mounted to the lid 340 at supports 360. In the compact storage configuration of portable water storage apparatus 100 shown in FIG. 1, latching buckles may be employed at 180 to fasten the lid 160 to the base 110. In the fully assembled configuration of the portable water storage apparatus 600 for storing and transporting water shown in FIG. 6, latching buckles may be employed at 680 to fasten the lid 660 to unfolded panels 650.

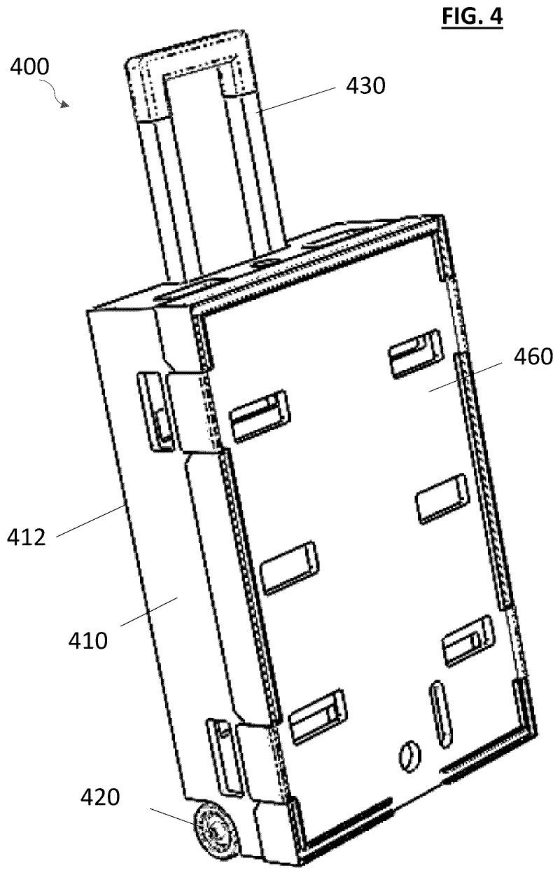

FIG. 4 shows transport configuration of a portable water storage apparatus 400 assembled for compact storage. In the transport configuration, the wheel assembly 420 rests on the underlying surface disposed for rolling movement of the water storage apparatus 400. The planar base surface 412 of the base 410 is oriented vertically (facing away from the viewer in this view) and the upper lid surface 460 is oriented vertically. The telescoping handle 430 is extended and is disposed for propelling rolling movement of the apparatus. Thus the apparatus can be conveniently transported in its compact storage configuration, e.g., to a location where it may be assembled and filled. It is to be appreciated that embodiments of handles 430 may be attached to the portable water storage apparatus at any number of locations such that the handles 430 are capable of aiding human grip and comfort when moving the water storage apparatus 400 by human-applied force.

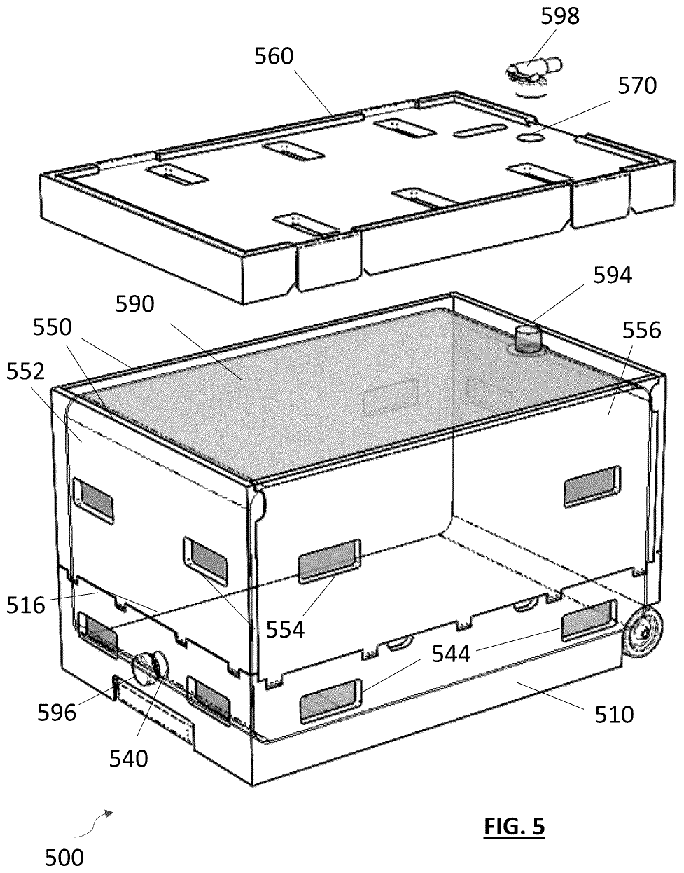

FIG. 5 shows a partially assembled portable water storage apparatus 500 in assembly configuration. In the assembly configuration, the base 510 rests on its planar base surface as lower horizontal surface of the apparatus. The panels 550 are unfolded to a vertical configuration in which the end panels 552 and side panels 556 extend vertically from the upper edges 516 of the base to the lid 560. In an embodiment, in the unfolded configuration the panels may interlock or otherwise fit to form a unified structure.

In the partially assembled view of FIG. 5 the lid 560 has not yet been attached to the panels and the dispensing outlet 598 has not yet been attached to lid 560. During assembly the flexible bladder 590 is inserted into a chamber defined by unfolded panels 550 and the recess of base 510. Flexible bladder 590 includes an outlet 594 at a side surface of the bladder and an outlet 596 at an upper surface of the bladder. During insertion the outlet 594 has been inserted through hole 540 in one of the end walls of base 510. When the lid 560 is subsequently attached over the panels 550 and bladder 590, outlet 596 at the upper surface of the bladder 590 is inserted through hole 570 is the upper surface of lid 560. The flexible bladder 590 may be viewed through windows 544 in base 510 and through windows 554 in panels 550.

FIG. 6 shows a fully assembled portable water storage apparatus 600 in horizontal assembly configuration. The lid 660 has been attached over the panels 650 using fasteners 680. In the fully assembled apparatus, the flexible bladder is contained within a chamber defined by the recess within base 610 and an interior space defined by unfolded panels 650. In an embodiment, the chamber containing the flexible bladder may also include a recess within lid 660. The exemplary embodiment of the water storage apparatus 600 shown in FIG. 6 is a rectangular prism or cuboid having six sides. However, it is to be appreciated that embodiments of the water storage apparatus 600 may comprise any number of sides capable of forming a chamber housing a bladder for fluid storage.

At a final stage of assembly, the user may attach a water fill fixture and a water dispensing fixture to the outlets of the flexible bladder extending through the holes in base 610 and lid 660. The user has attached a fill cap 692 to the outlet extending from base 610, and has attached a dispensing nozzle 698 to the outlet extending from lid 660.

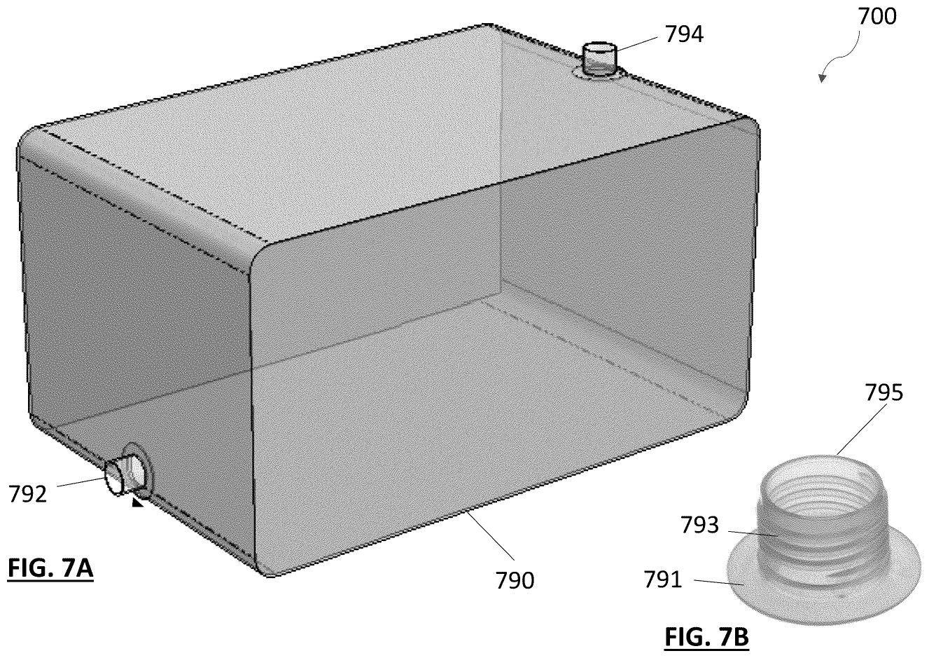

FIG. 7A shows a perspective view 700 of a flexible bladder 790. The flexible bladder includes outlets 792, 794 at side and upper surfaces of the bladder. In an embodiment, bladder 790 is formed of a food safe polymeric material such as BPA-free polyethylene. BPA is an abbreviation for Bisphenol A. FIG. 7B shows a close-up view of an outlet 795 including a base 791 and a threaded spout 793. The threaded surface of spout 793 provides a mechanism for attaching a filling attachment or dispensing attachment with complementary threaded surface. The outlet 795 may have a welded joint to the flexible bladder 790.

The bladder 790 in FIG. 7A is shown as being substantially cuboid in shape due to the exemplary embodiment shown in the figures. However, it is to be appreciated that embodiments of the bladder 790 are not limited to the shape shown in the exemplary embodiment of FIG. 7A or any other embodiment described herein.

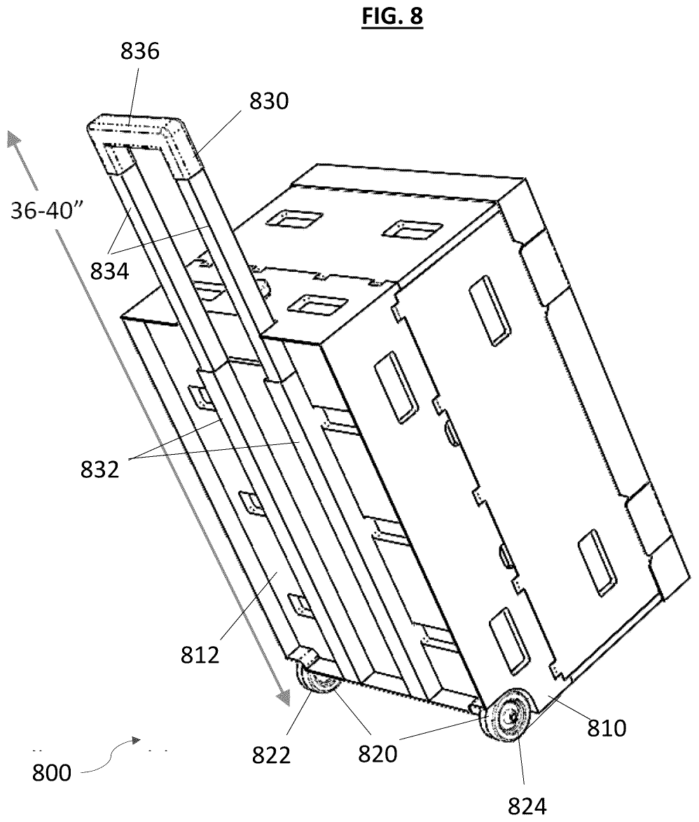

FIG. 8 shows a perspective view of fully assembled portable water storage apparatus 800 in transport configuration. In the transport configuration, the wheel assembly 820 rests on the underlying surface disposed for rolling movement of the water storage apparatus 800. Wheel assembly 820 includes recessed wheels 822, 824 mounted to the planar base surface 812 of the base 810. The planar base surface is oriented vertically, and supports a telescoping handle assembly 830. Telescoping handle assembly 830 includes concentric tubular sections with an outer section 832 and an inner section 834 configured to slide relative to one another. The telescoping handle sections include parallel telescoping sections, which are connected at handle cross-piece 836 including a grip surface. In the transport configuration shown in FIG. 8, the telescoping handle 830 is extended and is disposed for propelling rolling movement of the apparatus.

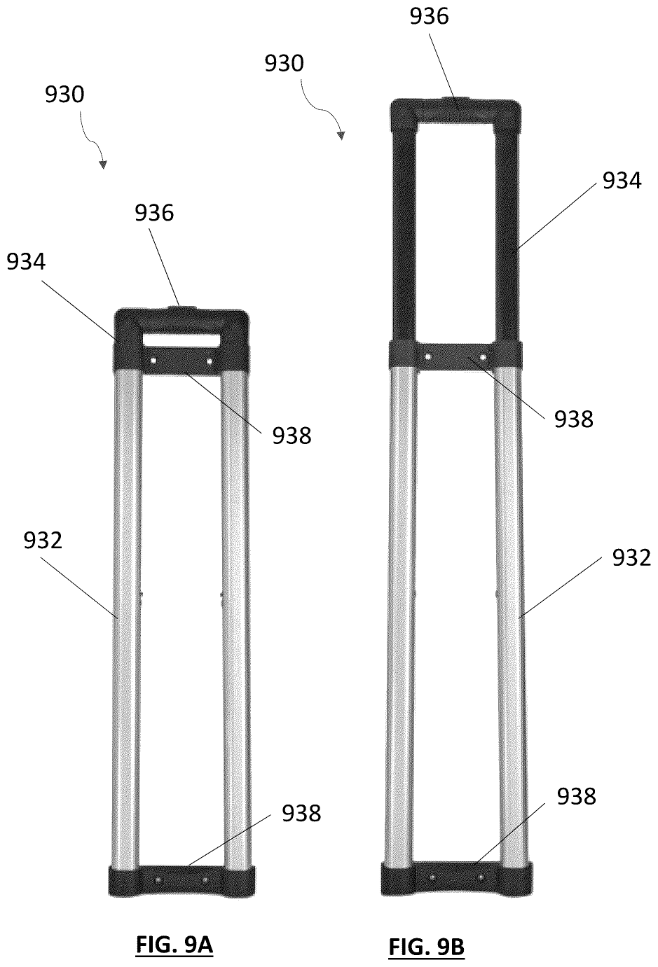

FIGS. 9A and 9B show elevated views of a telescoping handle assembly 930 respectively showing with handle retracted and handle extended. Telescoping handle assembly 930 includes concentric tubular sections with outer sections 932 and an inner sections 934 configured to slide relative to one another. The telescoping handle sections include parallel telescoping sections. Parallel inner sections 934 are connected at a terminal handle cross-piece 936 including a grip surface. Parallel outer sections 932 are connected at two structural cross-pieces 938 that provide support for the telescoping handle assembly.

FIG. 10 illustrates an end view of portable water storage apparatus 1000 showing wheel assembly 1050. Wheel assembly includes large outboard wheels 1010, 1020 mounted to an axle 1030 and may be configured to rotate about the axle 1030 or be fixed to the axle 1030 and rotate with the axle 1030. The axle 1030 may be rotatably mounted to the base 1010. The axle 1030 protrudes from side walls of base 1060 at 1040 to support the large outboard wheels 1010 and 1020. In an embodiment not shown, the wheel assembly may employ a split-axle design in which the wheel on a left side of the base is attached to a separate shaft than the wheel on a right side of the base. The split-axle design allows the left and right wheels to rotate at different speeds as the portable water storage apparatus turns.

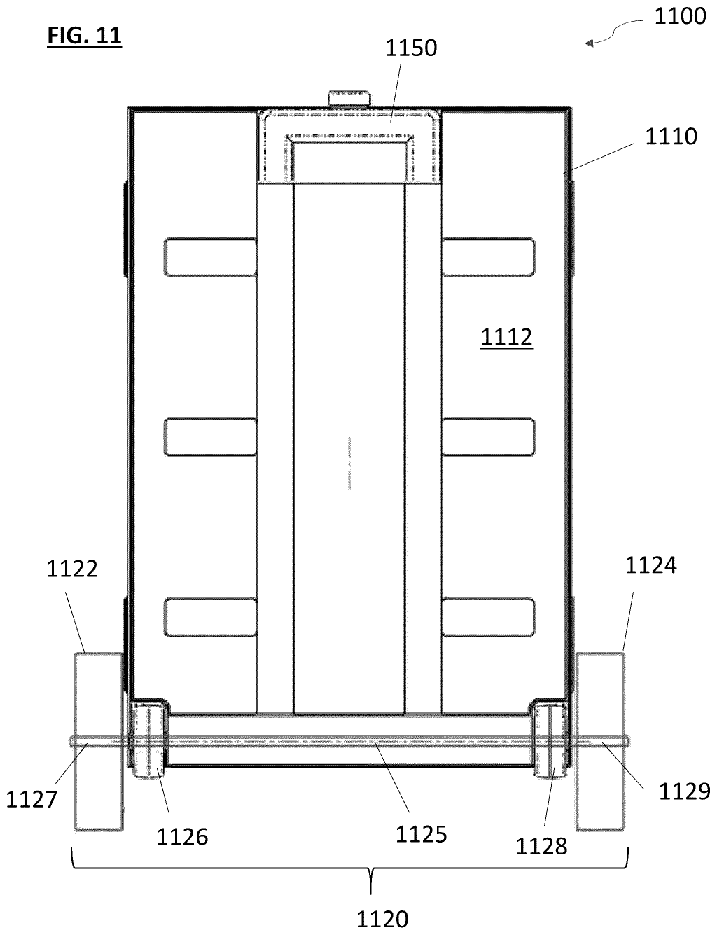

FIG. 11 shows a portable water storage apparatus 1100 in vertical transport configuration with handle 1150 retracted. FIG. 11 shows an elevation view of the planar base surface 1112 of base 1110. Water transport apparatus 1100 includes a wheel assembly 1120 with larger outboard wheels 1122, 1124 and smaller recessed wheels 1126, 1128. The wheels are mounted to an axle 1125 rotatably mounted to the base 1110. The axle 1125 protrudes from side walls of base 1110 at 1127 and 1129 to support the larger outboard wheels 1122 and 1124.

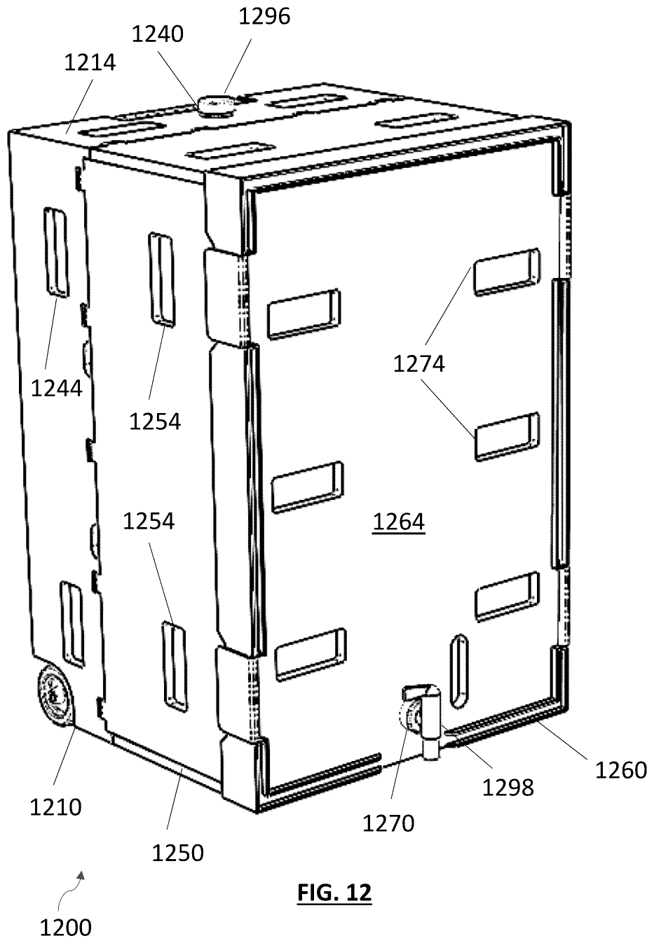

FIG. 12 shows a fully assembled portable water storage apparatus 1200 in vertical fill configuration. In this configuration, the planar lid surface 1264 of the lid 1260 and the planar base surface of the base 1210 are oriented vertically. A base wall 1214 of the base 1210 faces upwardly, including a filling hole 1240. A cap 1296 may seal the filling hole 1240 formed in the base wall 1214. The cap 1296 may prevent loss of the contents of the bladder and also may prevent contamination of the contents of the bladder. In some embodiments, a bladder (not shown) may comprise an orifice corresponding to the filling hole 1240 of the base. In some embodiments, a filling hose, pipe, funnel, or other means for delivering fluids may be attached to an exterior side of the filling hole 1240 and may deliver fluids to an orifice of a bladder attached at the interior side of the base 1210. In such embodiments, the corresponding orifice of the bladder may be detachably coupled to an interior side of the filling hole 1240 of the base 1210.

In the fill configuration, the planar lid surface 1264 of the lid 1260 faces sideways and includes a dispensing hole 1270 at a lower portion of the planar lid surface. A fluid dispensing attachment may be detachably coupled to the dispensing hole 1270, such as a nozzle 1298 or a hose. In some embodiments, a bladder may comprise an orifice corresponding to the dispensing hole 1270. In such embodiments, the corresponding orifice of the bladder may be detachably coupled to an interior side of the dispensing hole 1270 of the lid 1260. In some embodiments, an outer ring comprising a grommet, threaded ring, or other ring mechanism may circumscribe the dispensing hole 1270. Embodiments of an outer ring may provide a mechanism for attaching, screwing, or otherwise removably coupling a water dispenser attachment to the dispensing hole 1270.

The base 1210 defines windows 1244 that permit viewing of the flexible bladder within portable water storage apparatus 1200. Similarly, the panels 1250 define windows 1254 and the lid 1260 defines windows 1274 that permit viewing the flexible bladder within water storage apparatus 1200. These windows may permit the user to inspect the fill level of the bladder, and the like. Other arrangements of windows or transparent portions of the water storage apparatus may be employed for this purpose.

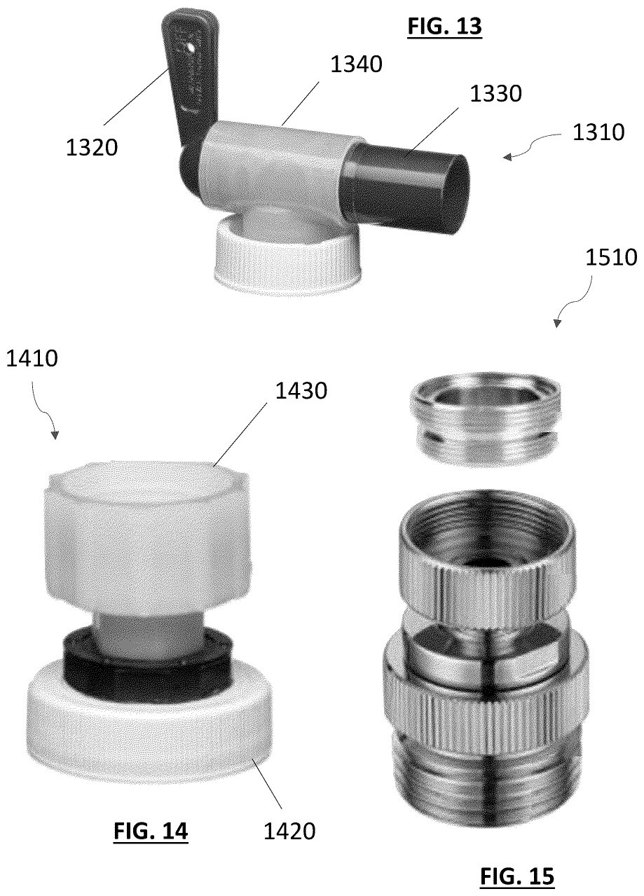

FIG. 13 shows a nozzle 1310 for a portable water storage apparatus. Nozzle 1310 may be a fast flow, self-venting nozzle that can be employed as a spigot at the dispensing hole of a portable water storage apparatus, such as spigot 1298 in FIG. 21. The nozzle includes a handle 1320 to open or close a valve, a nozzle 1330, and a mount 1340. FIG. 14 shows a garden hose adapter 1410, which includes a hose fitting 1430 and a threaded connector 1420 with a different thread type for coupling the garden hose adapter to an outlet of the portable water storage apparatus. FIG. 15 shows a household faucet aerator adapter 1510. This threaded faucet adapter enables attaching a garden hose connector directly to a sink faucet.

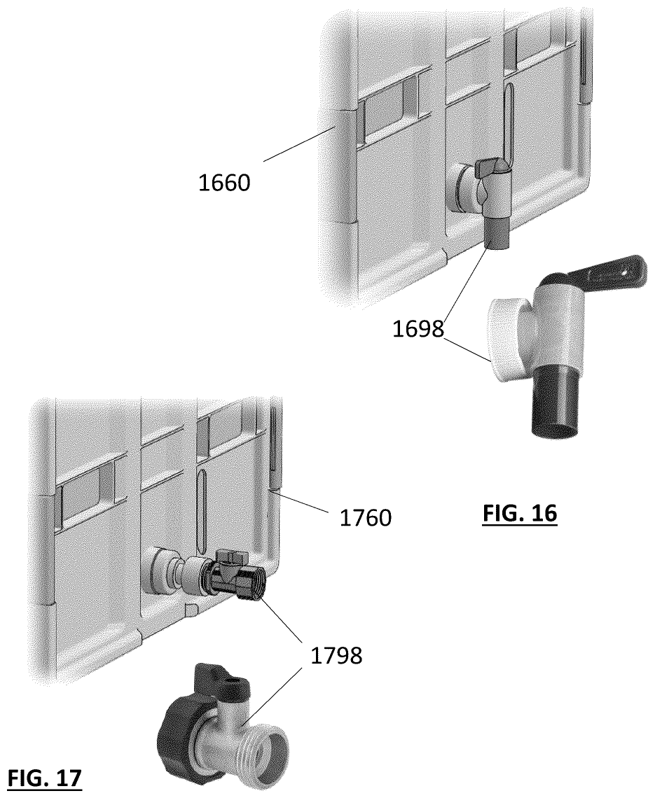

FIGS. 16 and 17 show water dispenser attachments for a dispensing outlet (1660, 1760) of a portable water storage apparatus. FIG. 16 shows a water dispenser attachment with nozzle 1698. FIG. 17 shows a water dispenser attachment with garden hose adapter 1798.

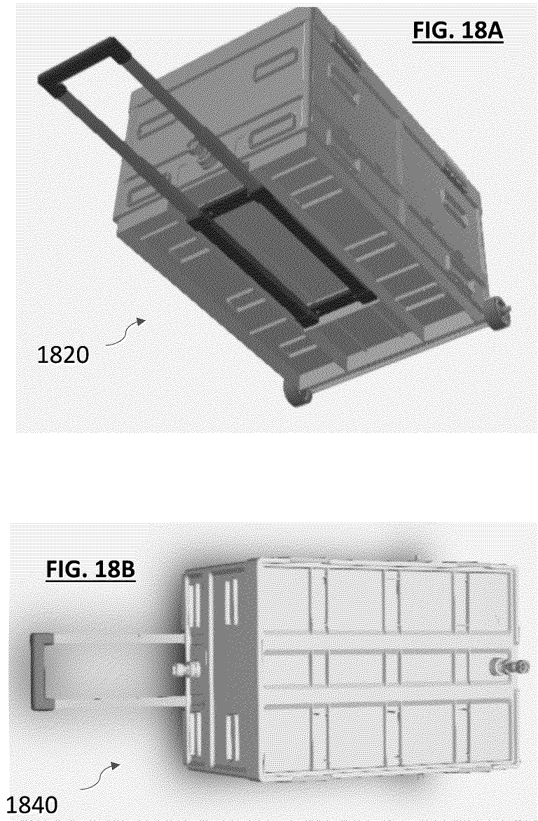

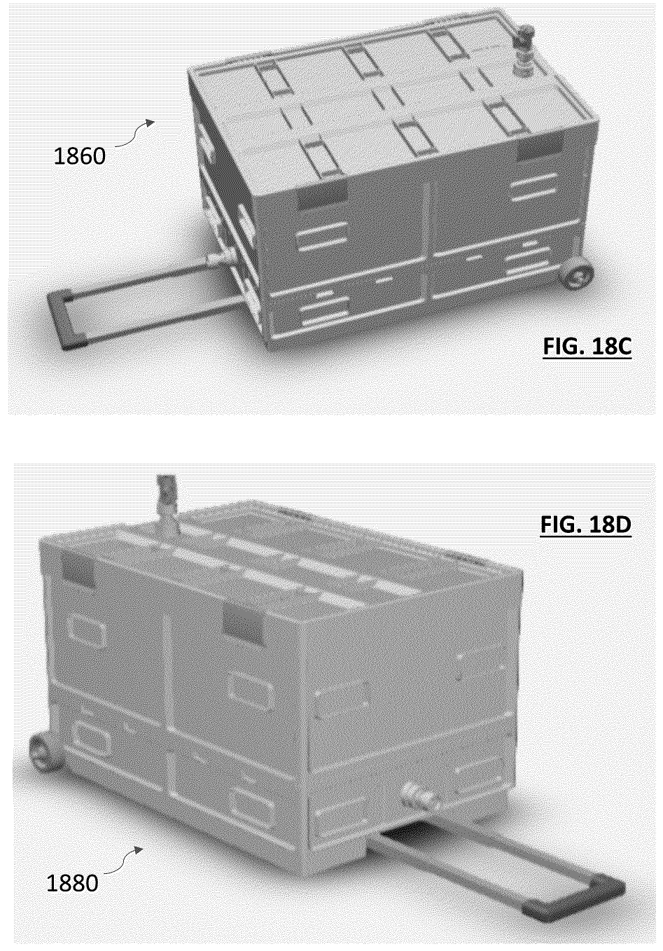

FIGS. 18A-18D show isometric views from various perspectives of a fully assembled portable water storage apparatus with handle extended. FIG. 18A shows a bottom view 1820. FIG. 18B shows a top view 1840. FIG. 18C shows a right side view 1860. FIG. 18D shows a left side view 1880.

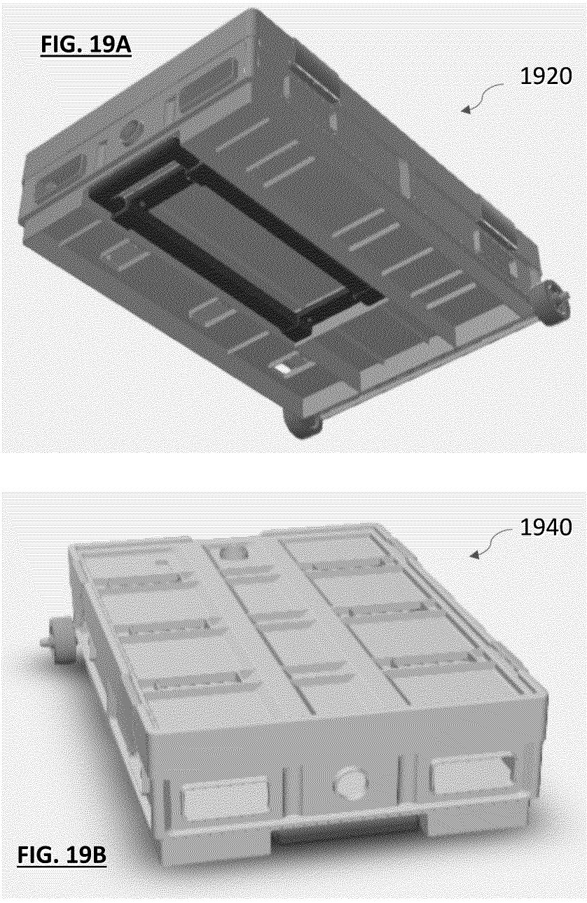

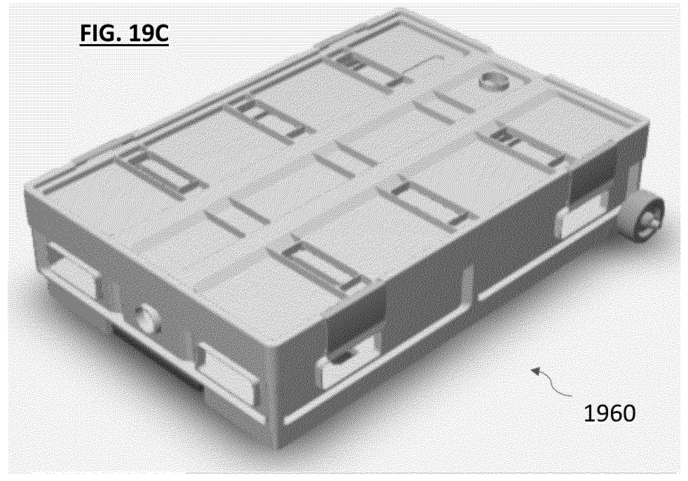

FIGS. 19A-19C show isometric views from various perspectives of a compact storage configuration of portable water storage apparatus. FIG. 19A shows a bottom view 1920. FIG. 19B shows a front side view 1940. FIG. 18C shows a top view 1960.

The exemplary embodiments described herein relate to an apparatus capable of storing and conveying water. However, it should be appreciated that embodiments of the invention are not intended to be limited to water. It is to be appreciated that embodiments of the invention may store and/or dispense any fluid. The exemplary embodiments can relate to an apparatus for performing one or more of the functions described herein. Skilled artisans may implement the described method and apparatus in varying ways for a particular use, but such implementation decisions should not be interpreted as causing a departure from the scope of the present invention. While various aspects and embodiments have been disclosed, other aspects and embodiments are contemplated. The various aspects and embodiments disclosed are for purposes of illustration and are not intended to be limiting, with the true scope and spirit being indicated by the following claims. The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A water storage apparatus comprising:
a base comprising a planar base surface and a plurality of base walls extending from edges of the base walls adjacent the planar base surface to opposite edges of the base walls non-adjacent the planar base surface, forming a recess in the base defined by the base walls and the planar base surface, wherein at least one of the plurality of base walls has a first hole configured to be detachably coupled to a fluid dispenser;
a lid comprising a planar lid surface and a plurality of lid walls extending from edges of the lid walls adjacent the planar lid surface to opposite edges of the lid walls non-adjacent the planar lid surface, wherein the planar lid surface has a second hole;
a plurality of panels coupled to the opposite edges of the base walls, wherein the panels have a folded configuration in which the panels form a stack of overlapping panels in the recess in the base, wherein the panels have an unfolded configuration in which the plurality of panels extends from the base to the lid forming a chamber defined by the plurality of panels, the base, and the lid; and
a flexible bladder comprising an orifice substantially aligned with the second hole in the planar lid surface.

2. The water storage apparatus of claim 1, further comprising a telescoping handle mounted to the planar base surface of the base.

3. The water storage apparatus of claim 1, wherein the telescoping handle comprises concentric tubular sections configured to slide relative to one another.

4. The water storage apparatus of claim 1, wherein the lid includes a plurality of fasteners configured to secure the lid to the base walls in the folded configuration of the plurality of panels and configured to secure the lid to the plurality of panels in the unfolded configuration of the plurality of panels.

5. The water storage apparatus of claim 1, wherein the plurality of panels includes two end panels and two side panels foldably coupled to hinges at the opposite edges of the base walls.

6. The water storage apparatus of claim 1, wherein the plurality of panels includes two end panels and two side panels that cover the recess in the base in the folded configuration of the panels.

7. The water storage apparatus of claim 6, wherein in the folded configuration of the panels, the stack of overlapping panels comprises two side panels overlapping each other, and the two side panels are partially covered by the two end panels.

8. The water storage apparatus of claim 1, wherein the fluid dispenser detachably coupled to the first hole in the at least one of the plurality of base walls is selected from the group consisting of a spigot and a hose.

9. The water storage apparatus of claim 1, wherein the bladder further comprises an orifice detachably connected to the first hole in the at least one of the plurality of base walls.

10. The water storage apparatus of claim 1, wherein the lid forms a recess defined by the lid walls and the planar lid surface.

11. The water storage apparatus of claim 1, further comprising a removable cap sealing the second hole in the planar lid surface.

12. The water storage apparatus of claim 1, further comprising a detachable hose connected to the second hole in the planar lid surface.

13. The water storage apparatus of claim 1, further comprising wheels removably attached to the planar base surface.

14. The water storage apparatus of claim 1, further comprising an axle attached to the base, wherein the wheels are rotatably coupled to the axle.

15. The water storage apparatus of claim 13, further comprising an axle protruding from a first wall of the plurality of base walls, wherein the wheels comprise outboard wheels rotatably coupled to the axle.

16. A water storage apparatus comprising:
a base comprising a lower surface, a wheel assembly attached to the base, a handle mounted to the base, and a plurality of walls extending upwardly from edges of the lower surface to upper edges of the walls forming a recess in the base defined by the walls and the lower surface, wherein at least one of the plurality of walls has a hole;
a lid comprising an upper surface having a plurality of walls extending downwardly from edges of the upper surface, forming a recess in the lid defined by the lid walls and the upper surface, wherein the upper surface comprises a hole;
a plurality of panels foldably coupled to the upper edges of the walls of the base, wherein the panels have a folded configuration in which the panels form a stack of overlapping panels covering the recess in the base; and
a flexible bladder comprising an orifice substantially aligned with the hole of the upper surface,
wherein in a transport configuration of the water storage apparatus the wheel assembly is disposed for rolling movement of the water storage apparatus, the lower surface of the base is oriented vertically, and the handle is disposed for propelling the rolling movement.

17. The water storage apparatus of claim 16, wherein the handle is a telescoping handle, wherein in the transport configuration of the water storage apparatus the telescoping handle is extended for propelling the rolling movement.

18. The water storage apparatus of claim 17, wherein the telescoping handle comprises concentric tubular sections configured to slide relative to one another.

19. The water storage apparatus of claim 16, wherein in an assembly configuration of the water storage apparatus the lower surface of the base is a lower horizontal surface, the upper surface of the lid is an upper horizontal surface, and the folded configuration of the panels forms a horizontal stack of overlapping panels covering the recess in the base.

20. The water storage apparatus of claim 19, wherein the wheel assembly is removably attached at a lower side of the lower horizontal surface of the base in the assembly configuration of the water storage apparatus.

21. The water storage apparatus of claim 16, wherein the panels have an unfolded configuration in which the plurality of panels extends from the base to the lid forming a chamber defined by the plurality of panels, the base, and the lid.

22. The water storage apparatus of claim 21, wherein the lid includes a plurality of fasteners configured to secure the lid to the walls of the base in the folded configuration of the plurality of panels and configured to secure the lid to the plurality of panels in the unfolded configuration of the plurality of panels.

23. The water storage apparatus of claim 16, wherein the hole in the at least one of the plurality of walls of the base is configured to be detachably coupled to a fluid dispenser selected from the group consisting of a spigot and a hose.

24. The water storage apparatus of claim 16, wherein the wheel assembly comprises an axle that protrudes from first and second walls of the plurality of walls of the base and outboard wheels.
